(19) United States
(12) Patent Application Publication
(10) Pub. No.: US 2022/0205223 A1
(43) Pub. Date: Jun. 30, 2022

(54) Method for Calculating an Excavation Volume

(71) Applicant: Robert Bosch GmbH, Stuttgart (DE)

(72) Inventors: Christian Krause, Stuttgart (DE); Markus Schleyer, Ludwigsburg (DE); Boris Buchtala, Muehlacker (DE); Steffen Rose, Kirchheim Am Neckar (DE); Kai Liu, Asperg (DE); Horst Wagner, Niederstotzingen (DE); Erik Hass, Karlsruhe (DE); Bilge Manga, Leonberg (DE)

(21) Appl. No.: 17/595,347

(22) PCT Filed: May 7, 2020
(86) PCT No.: PCT/EP20/62644

§ 371 Date: Nov. 15, 2021

(30) Foreign Application Priority Data
May 16, 2019 (DE) 10 2019 207 165.1

(51) Int. Cl. E02F 9/26; E02F 3/30

(52) U.S. Cl. CPC E02F 9/264; E02F 3/301; E02F 9/261

(57) ABSTRACT

A method calculates an excavation volume that was excavated by a construction machine using a tool. A motion trajectory of the tool over time is determined using one or more of the following sensors: inertial measurement unit, angle sensors, and linear sensors. At least part of the motion trajectory is classified based on machine load data as an excavation trajectory during which excavation occurs. The excavation volume is calculated using the excavation trajectory and dimensions of the tool.

The present invention relates to a method for calculating an excavation volume, which was excavated by a working machine by means of a tool. The invention further relates to a computer program, which performs each step of the method when it runs on a computer, as well as a machine-readable storage medium, which stores the computer program. Lastly, the invention relates to an electronic control device, which is configured to carry out the method according to the invention.

### PRIOR ART

Algorithms for determining the kinematic chain are known. One or several of the following sensors inertial measuring unit (IMU, inertial measuring unit), angle sensors, linear sensors, which send sensor data to a computer, is arranged at each member of the tool arm for this purpose. The sensor data determined in this way are filtered individually for each sensor and are fused relative to a stationary inertial coordinate system for the state estimation of the orientation of the respective sensor. Such an algorithm is used in the case of the tool center point estimation. The tool center point estimation is an algorithm for the state estimation of orientation and position of an end effector. The end effector is in particular a tool or a part of a tool, which has a tool arm comprising several members, which are connected via joints.

Typically used methods are described in the paper by Nikolas Trawny and Stergios I. Roumeliotis. “Indirect Kalman filter for 3D attitude estimation” University of Minnesota, Dept. of Comp. Sci. & Eng., Tech. Rep 2 (2005), in the paper by Robert Mahony, Tarek Hamel, and Jean-Michel Pflimlin, “Nonlinear complementary filters on the special orthogonal Group”, IEEE Transactions on automatic control 53.5 (2008): 1203-1218, as well as in the paper by Sebastian Madgwick, “An efficient orientation filter for inertial and inertial/magnetic sensor arrays” Report x-io and University of Bristol (UK) 25 (2010), to which reference is made in this respect.

The orientation of the member, at which the sensor is arranged, is initially determined from the orientation of the sensor, which is estimated in this way. This is performed for all members of the tool arm. If the kinematics is known (for example if the Denavit-Hartenberg parameters are known), the joint angle of the joint, which connects the two members, can be calculated from the relative orientation of two consecutive members. If, lastly, all joint angles and the dimensions of the members are known, the total configuration of the tool arm follows directly from the forward kinematics and thus the orientation and position of the end effector.

For a detailed description, reference is made to the paper by Mark W. Spong, Seth Hutchinson, and Mathukumalli Vidyasagar, “Robot modeling and control”, Vol. 3. New York: Wiley, 2006.

A measurement of quantities, which refers to the scope of the provided construction services, is calculated on construction sites. According to the construction tendering and contract regulations in the construction industry (VOB), Part B, the measurement of quantities is to be prepared jointly by the customer and the contractor, if possible. For the most part, they are initiated during the ongoing operation at the construction site because additional work makes it more difficult to determine the measurement of quantities of previous construction services beforehand, for example when the additional work covers an excavation. The measurement of quantities is the basis for a remuneration, thus the basis for the generation of an invoice.

### DISCLOSURE OF THE INVENTION

A method for calculating an excavation volume, which was excavated by a construction machine by means of a tool, is introduced. A motion trajectory of the tool over time is thereby determined with the help of one or several of the following sensors: inertial measuring unit, angle sensor, linear sensor, at least during the excavation. The motion trajectory represents the motion of the tool in space over time. For this purpose, a position of a point at the tool can preferably be traced in space over time. Using the example of an excavator shovel, such a point is a cutting edge, by means of which material is separated.

The tool, a working arm, which is arranged between the tool and the construction machine in embodiments, and the construction machine form a kinematic chain. At the least, the sensors are arranged at at least a part of the tool and are preferably arranged at each member of the kinematic chain between the construction machine and the tool. Inertial measuring units can be retrofitted easily and cost-efficiently and can be used for other methods.

The motion trajectory is advantageously determined by means of an algorithm for determining the kinematic chain between the tool and the construction machine. In the case of the algorithm for determining the kinematic chain, the position of the above-mentioned point at the tool is preferably determined, and the change of the position of the point in space over time is recorded as motion trajectory. Particularly preferably, said point is a tool center point, i.e. an end effector, which acts on the material during the excavation, and the algorithm is a tool center point estimation. The algorithm for determining the kinematic chain is based on sensor signals of the above-mentioned sensors.

The motion trajectory of the tool is divided and classified into different parts. The classifying or the classification, respectively, thereby takes place directly from machine load data. The classification makes it possible to differentiate a part of the motion trajectory, at which an excavation has taken place (referred to below as excavation trajectory) from a part of the motion trajectory, at which no excavation occurs. At least a part of the motion trajectory is classified by means of the machine load data as excavation trajectory, during which an excavation occurs. For this purpose, the point in time at which the machine load data display an excavation, can be determined, and the position at this point in time can be determined from the motion trajectory as start position for the excavation trajectory. In addition, the point in time at which the machine load data no longer display an excavation can be determined, and the position at this point in time can be determined from the motion trajectory as end position for the excavation trajectory. The excavation trajectory then runs between the start position and the end position.

The machine load data preferably comprise physical data of the construction machine and/or of the tool. For example, the machine load data can comprise the prevailing performance, load variations, torque profiles, points in time of injections and/or pressure profiles of valve pressures of consumers. The machine load data can be determined by means of sensors, e.g. by means of pressure sensors in the consumers, or they have already been determined otherwise, and are available in an electronic control device. In the case of an excavator shovel, for example, it can be determined by means of the pressures and loads in the cylinder, when the excavation took place. The machine load data therefore serve as characteristic for the excavation by means of the tool. The processing of the data can be performed directly on the electronic control device. In addition or in the alternative, even the machine load data can also be gradients of the mentioned variables.

On the one hand, the classification or the classifying, respectively, of the motion trajectory can take place via static conditions. The parts of the motion trajectory are differentiated thereby when one of the corresponding machine load data exceeds or falls below a threshold. The thresholds are selected in such a way for the machine load data that an excavation is characterized by exceeding. In the alternative or in addition, the thresholds for the gradients of the load can be selected. For example, the excavation trajectory can be detected when the pressure in a consumer exceeds the corresponding threshold. Additional conditions can furthermore be considered, such as, e.g., an active injection of a combustion engine. The injection of the combustion engine is characteristic for the torque output at the crankshaft. Together with the rotational speed, a mechanical power results, which is transformed into a hydraulic power by means of the pumps. Drive cylinders of the working arm, in turn, transform the hydraulic power into a mechanical power of the tool. The power at the tool is thus observable by the power at the combustion engine. The force exerted by the tool can be calculated from the power at the tool and the motion speed thereof. If the ground soil exerts a counterforce on the tool, for example by piercing or breaking loose material, a quick increase of the performance requirement results. It can be determined therewith whether ground soil is removed and moved, or whether the tool is moved, without excavating material. The transition between these states marks the current earth's surface. In addition to the above-mentioned variables injection volume, pressure, a force measurement at the tool or at the joints of the working arm is also possible. Force sensors or strain gauges can be provided for this purpose.

In the alternative, coupled conditions can be provided, i.e. that the motion trajectories are differentiated when several machine load data simultaneously exceed or fall below the respective threshold and/or when one or several of the additional conditions is additionally met. One example for coupled conditions is that the excavation trajectory is detected when the pressure in one or several consumers exceeds the threshold, a load variation is determined, and the injection of the combustion engine is active at the same time.

On the other hand, the classification of the motion trajectories can take place by means of machine learning. The motion trajectories are thereby differentiated on the basis of classifiers, which are trained with reference situations recorded in advance. For this purpose, each operating procedure of the construction machine is preferably recorded, assessed, and divided into reference classes. The motion trajectories are then classified by means of the classifiers on the basis of the reference classes for the operating procedures. A beginning, an end, and a duration of the operating procedure are determined for the classification. These points in time can serve as training data for the classifiers on the one hand, or can be determined by means of above-mentioned conditions on the other hand.

Updates can be provided during the classification by means of machine learning, for example in the form of software updates, in the case of which individual and/or improved models are provided for the classification of the motion trajectories. In addition, the results of the classification of the motion trajectories, in turn, can serve as training data, in order to train the classifier. An additional terminal, which records at least the motion of the tool, is optionally provided for this purpose.

During the classifying of the motion trajectory by means of the machine load data, the type of the material to be excavated is advantageously considered, because the machine load data differ, depending on the type of the excavated material, e.g. top soil, sandy soil, gravel, etc. The static conditions, in particular the thresholds, are thus selected as a function of the material to be excavated. During the machine learning, the material is trained in additional reference situations, and the reference classes comprise subclassifications, which consider the material to be excavated, and the classifiers are activated as a function of the material to be excavated.

If at least one excavation trajectory is determined, the excavation volume is calculated by including the excavation trajectory and the dimensions of the tool. The excavation volume specifies the volume of the removed material, which is excavated during the movement of the tool along the excavation trajectory. The excavation volume is calculated in that the excavation trajectory from the start position to the end position serves as length of the excavation volume, and the width and height of the excavation volume correspond to the dimensions of the tool, in the example of an excavator shovel, the width and height thereof.

It can additionally be considered that, as a function of the operating procedures, the excavation trajectory are located at certain positions relative to the construction machine. In the case of an excavator as example, the excavation trajectory of the excavator shovel is mostly located below the bearing surface of the excavator. In the case of other applications, a reference to an upper removal surface will be determined in a different way. For example, this reference can be determined via a combination of available terrain models and the position of the excavator in global coordinates. If the earthmoving takes place for the purpose of a construction project, the current surface can be displayed by means of a terrain model, and a target state of the construction project can be predefined by means of CAD models in global coordinates. To be able to interpret the motion trajectories in relation to the CAD models, the position of the excavator is specified in global coordinates. By means of coordinate transformation, a switch can be made between a display of the excavator and/or of the tool in reference coordinates and global coordinates.

A measurement of quantities can advantageously be calculated from the excavation volumes for several operating procedures. The measurement of quantities can be calculated, on the one hand, in that the excavation volume for these operating cycles is summed. On the other hand, the measurement of quantities can be calculated in that a space integral for the excavation volumes is calculated between the first and the last operating cycle. The measurement of quantities identifies the scope of the provided construction services. The measurement of quantities can thus be determined during the performance of the construction service, directly after the performance of the construction service, or afterwards, when the excavation trajectories or the motion trajectories as well as the machine load data are stored. This way of determining the measurement of quantities provides several advantages: on the one hand, the measurement of quantities can thus be determined automatically, and does no longer need to be performed by hand on location at the construction site. Secondly, the process at a construction site is not interrupted by the manual measuring of the measurement of quantities. Instead, follow-up work can be performed directly. Thirdly, the measurement of quantities can also be generated subsequently, when the excavation trajectories or the motion trajectories are stored together with the machine load data. Unprecise estimates or cost-intensive follow-up measurements, such as, e.g., ultrasonic measurements of the ground soil thus become unnecessary.

The measurement of quantities can be used for the automated billing of the amount of work. For this purpose, the provided construction services can be compared to a schedule of services, in order to bill the amount of work. This provides the advantage that the accuracy of the billing is increased because the actually performed construction services are taken into account by means of a direct recording of the excavation. In addition, the determined measurement of quantities is legally binding because a certified measuring method is applied in particular for the tool center point estimation.

The determined excavation volume can furthermore be referenced in a virtual map. The excavation volume can then be visualized to an operator. A terrain geometry and additional relevant information, such as, e.g., the position of pipelines or other infrastructure located in the ground, can additionally be displayed in the virtual map. A work assignment established in advance can furthermore be compared to the actual excavation volume.

A storage position of material can furthermore additionally be determined from the motion trajectory, and it can be used when determining the measurement of quantities. With this knowledge of the storage position and of the corresponding means of transport (e.g. in which heavy goods vehicle or on which conveyor belt), the material transport can be captured and documented. Lastly, the material transport can be billed, preferably as a function of the material type. Depending on the material, the costs change. For example, construction waste has to be disposed of for a fee, while gravel can be reused or sold.

The method advantageously has a step of the outputting of a control signal as a function of the calculated excavation volume. The control signal can be output to a display unit of the construction machine and can comprise the excavation volume, in order to display the excavation volume to an operator of the construction machine.

The computer program is configured to perform each step of the method, in particular when it is performed on a computer or control device. It provides for the implementation of the method in a conventional electronic control device, without having to make structural changes thereto. For this purpose, it is stored on the machine-readable storage medium.

By uploading the computer program to a conventional electronic control device, the electronic control device is obtained, which is configured to calculate an excavation volume.

### BRIEF DESCRIPTION OF THE DRAWINGS

Exemplary embodiments of the invention are illustrated in the drawings and are described in more detail in the following description.

FIG. 1 shows a schematic illustration of a construction machine and of an excavation volume.

FIG. 2 shows a flow chart of an embodiment of the method according to the invention.

FIG. 3 shows a flow chart of a further embodiment of the method according to the invention.

FIG. 4 shows a flow chart according to an exemplary embodiment, which connects to one of the flow charts from FIG. 2 or FIG. 3.

FIG. 5 shows a further flow chart according to a further exemplary embodiment, which connects to one of the flow charts from FIG. 2 or FIG. 3.

### EXEMPLARY EMBODIMENTS OF THE INVENTION

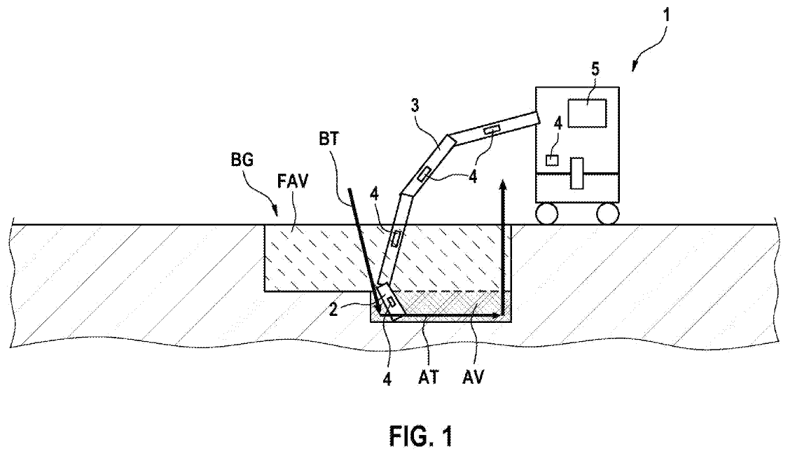

FIG. 1 shows a schematic illustration of a construction machine 1 in the form of an excavator comprising a tool 2, which is formed as a shovel. The tool 2 is movably connected to the construction machine 1 via a multi-member working arm 3. The construction machine 1, the working arm 3, and the tool 2 form a kinematic chain. An inertial sensor 4 of an inertial measuring unit is in each case arranged on each member of the kinematic chain. The inertial sensors are connected to an electronic control device 5 and send sensor signals to it.

The construction machine 1 uses the tool 2 to excavate an excavation pit BG. A tool center point of the tool 2 thereby moves along a motion trajectory BT. The tool center point is a cutting edge tool 2 and the position of the tool center point in space is determined and tracked by means of the sensors 4 over time. An excavation trajectory AT is part of the motion trajectory BT and is characterized in that an excavation occurs and material is received in the tool 2 during the movement of the tool 2 along the excavation trajectory AT.

Moreover, an excavation volume AV is illustrated, which is excavated by the tool 2 by means of the excavation along the excavation trajectory. The excavation pit BG is thus expanded by this excavation volume AV. The excavation volume AV is calculated by means of the method according to the invention, as shown below. In addition to the currently excavated AV, previous excavation volumes FAV are also shown, by means of which the excavation pit BG was created.

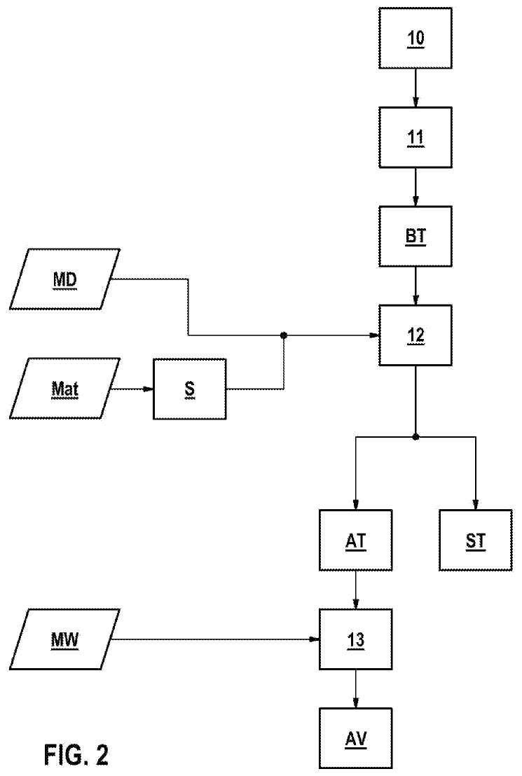

FIG. 2 shows a flow chart of a first embodiment of the method according to the invention. At the beginning and during the entire method, the position of the tool center point of the tool 2 is determined 10 as an algorithm for determining the kinematic chain by means of the tool center point estimation. The sensor data of the inertial sensors 4 along the kinematic chain are used for this purpose, and the position and the orientation of the tool in space are then determined from the orientation and the position of the members by means of so-called Denavit-Hartenberg parameters (see, for example, Spong et al. “Robot modeling and control”, Vol. 3. New York: Wiley, 2006). The position of the tool 2, thus of the tool center point, is recorded over time and a motion trajectory BT of the tool 2 is determined 11 therefrom.

This is followed by a classification 12 by means of machine load data MD, which, in this embodiment, takes place with the help of thresholds S. During the classification 12, a division of the motion trajectory BT into the excavation trajectory AT takes place, at which an excavation occurs, and into other trajectories ST, at which no excavation occurs, but the tool 2 is moved, for example, into the excavation pit BG or to an unloading point (not illustrated). The machine load data MD serve as a characteristic for the beginning, the duration, and the end of the excavation. Examples for the machine load data MD are a prevailing performance, a load variation, a torque profile, a point in time of the injection, and/or a pressure profile of valve pressures of consumers. On the one hand, the machine load data MD are determined by means of additional sensors (not shown here), e.g. in the case of valve pressures by means of pressure sensors in the consumers. On the other hand, the machine load data MD are determined by means of other methods, which are known per se, and are available in the electronic control device 5. In this exemplary embodiment for an excavator shovel, it is determined on the basis of the pressures and loads in the cylinder when the excavation took place. The processing of the machine load data MD is performed directly on the electronic control device 5.

The thresholds S are selected for the machine load data MD in such a way that an exceeding of the machine load data MD characterizes the excavation. The thresholds S can be selected here for absolute values of the machine load data MD or for gradients of the machine load data MD. As examples, one threshold S can in each case be selected for the pressure, the torque, and the injection volume of a combustion engine, as well as for the pressure gradient, the gradient of the torque, and the gradient of the injection volume. On the one hand, the differentiation can occur during the classification 12 when only one of the machine load data MD exceeds the corresponding threshold S. For example, the excavation trajectory AT is classified when the pressure in a consumer exceeds the threshold S. Additional conditions, such as, e.g., an active injection, can be considered in additional exemplary embodiments. On the other hand, the differentiation can take place during the classification when coupled conditions are met. For example, the excavation trajectory AT is classified when the pressure in a consumer exceeds the threshold S, a load variation is determined, and the injection is active at the same time. Since the machine load data MD are different during the excavation of different materials, e.g. top soil, sandy soil, gravel, etc., the thresholds S are selected as a function of the type of the material to be excavated.

The excavation trajectory AT is subsequently used in combination with dimensions MW of the tool 2 for the calculation 13 of the excavation volume AV, which was excavated along the excavation trajectory AT. The excavation trajectory AT here serves as length of the excavation volume AV, and the width as well as the height of the excavation volume AV correspond to the width and the height of the tool 2. Even though the excavation trajectory AT illustrated in FIG. 1 runs in a straight manner, it is mostly curved in practice. An integration can be performed in order to calculate the excavation volume AV.

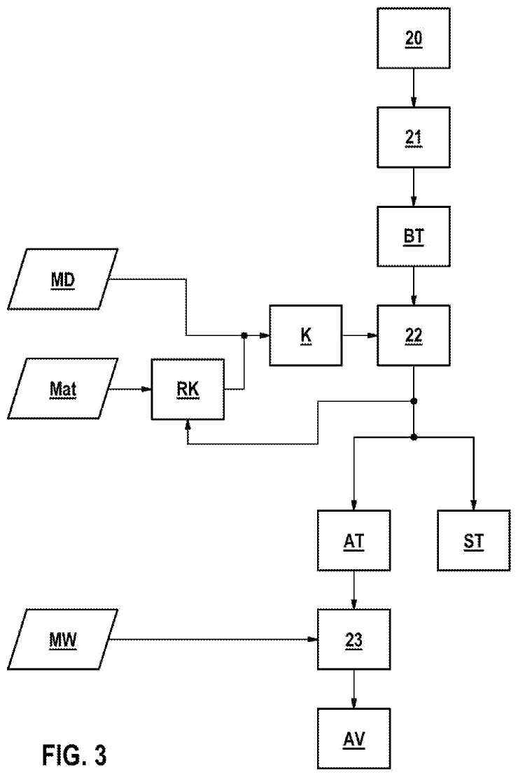

FIG. 3 shows a flow chart of a second embodiment of the method according to the invention. Analogously to the first exemplary embodiment, the position of the tool center point of the tool 2 is determined 20 in the same way at the beginning and during the entire method by means of the tool center point estimation as an algorithm for determining the kinematic chain. The position of the tool 2, thus of the tool center point, is likewise recorded over time, and a motion trajectory BT of the tool 2 is determined 21 therefrom.

This is followed by a classification 22 by means of machine load data MD, which, in this example, takes place with the help of a classifier K by means of machine learning. Also here, during the classification 22, a division of the motion trajectory BT into the excavation trajectory AT takes place, at which an excavation occurs, and into other trajectories ST, at which no excavation occurs. The machine load data MD correspond to those of the first exemplary embodiment and reference is made to them. The classifier K is trained with reference situations recorded in advance. For this purpose, each operating procedure of the construction machine 1 is recorded, assessed, and divided into reference classes RK in advance. The motion trajectories BT are then classified 22 by means of the classifier K on the basis of the reference classes RK for the operating procedures. A beginning, an end, and a duration of the operating procedure are determined for the classification 22, wherein these points in time likewise serve as training data for the classifier K. Since the machine load data MD are different during the excavation of different materials, e.g. top soil, sandy soil, gravel, etc., additional reference situations with different materials Mat to be excavated are trained in advance. The reference classes comprise subclassifications, which consider the material Mat to be excavated, and the classifiers are activated as a function of the material Mat to be excavated. After the classification 22, the result is then used, in turn, in order to update the reference classes RK and to thus teach the classifier K.

Analogously to the first exemplary embodiment, the excavation trajectory AT is subsequently used in combination with dimensions MW of the tool 2 for the calculation 23 of the excavation volume AV. The excavation trajectory AT here serves as length of the excavation volume AV, and the width as well as the height of the excavation volume AV correspond to the width and the height of the tool 2. Even though the excavation trajectory AT illustrated in FIG. 1 runs in a straight manner, it is mostly curved in practice. An integration can be performed in order to calculate the excavation volume AV.

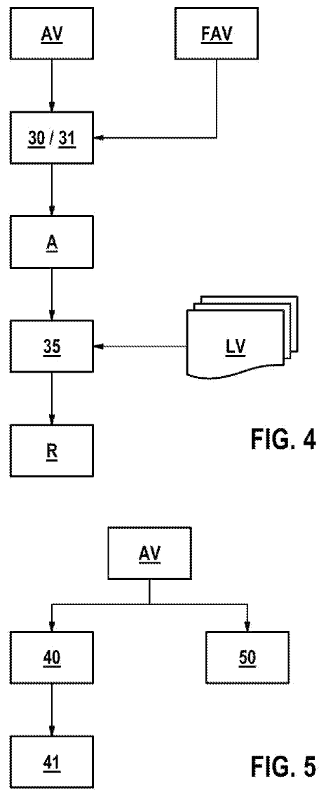

FIGS. 4 and 5 in each case show a flow chart, which connects to one of the flow charts from FIG. 2 or FIG. 3, and they relate to applications according to the invention of the calculated excavation volume AV. The applications described below can be performed alone or in combination with one another. In the exemplary embodiment of FIG. 4, the excavation volume AV is used in order to generate an invoice R in an automated manner. For this purpose, the excavation volume AV as well as previous excavation volumes FAV, which were determined by means of the same method, are summed 30, in order to obtain a measurement of quantities A. In the alternative, a space integral 31 for the excavation volume and the previous excavation volumes between the first and the last operation is calculated, in order to obtain the measurement of quantities A. The measurement of quantities A identifies the scope of the provided construction services. Since the above-mentioned data are stored, the measurement of quantities A can be calculated during the excavation on the one hand, directly after the excavation on the other hand, or afterwards. The measurement of quantities A is subsequently compared 35 to a schedule of services LV, in order to bill the provided construction services. The invoice R is generated based on the measurement of quantities A and the comparison 35 to the schedule of services LV.

In the exemplary embodiment of FIG. 5, the excavation volume AV is referenced 40 in a virtual map. The virtual map is then visualized 41 to an operator, for example at a terminal inside a driver's cab of the construction machine 1. A terrain geometry and additional relevant information, such as, e.g., the position of pipelines or other infrastructure located in the ground, are thereby illustrated in the virtual map.

The determined excavation volume AV is furthermore compared 50 to a planned excavation volume GAV, and the result is used for assessing the accuracy, the efficiency, and/or additional factors.

1. A method for calculating an excavation volume, which was excavated by a construction machine using a tool, the method comprising:
determining a motion trajectory of the tool over time using at least one of an inertial measuring unit, angle sensors, and linear sensors;
classifying at least a part of the determined motion trajectory based on machine load data as an excavation trajectory, during which an excavation occurs; and
calculating the excavation volume based on the excavation trajectory and dimensions of the tool.

2. The method as claimed in claim 1, wherein the motion trajectory is determined based on an algorithm for determining a kinematic chain of the construction machine.

3. The method as claimed in claim 1, wherein the machine load data comprise physical data of the construction machine and/or of the tool.

4. The method as claimed in claim 1, wherein the classifying takes place via static conditions.

5. The method as claimed in claim 1, wherein the classifying takes place via machine learning.

6. The method as claimed in claim 1, wherein during the classifying, a type of material to be excavated is considered.

7. The method as claimed in claim 1, wherein a measurement of quantities is calculated and includes summing the excavation volume for several operating procedures of the construction machine.

8. The method as claimed in claim 1, wherein a measurement of quantities is calculated and includes calculating a space integral for the excavation volumes between a first and a last operating cycle of the construction machine.

9. The method as claimed in claim 7, wherein the measurement of quantities is used for an automated billing of an amount of work for excavating an excavated material.

10. The method as claimed in claim 1, further comprising:
outputting a control signal as a function of the calculated excavation volume.

11. The method as claimed in claim 1, wherein a computer program is configured to perform the method.

12. The method as claimed in claim 11, wherein the computer program is stored on a non-transitory machine-readable storage medium.

13. The method as claimed in claim 1, wherein an electronic control device, is configured to calculate the excavation volume using the method.
